(19) United States
(12) Patent Application Publication
(10) Pub. No.: US 2026/0140774 A1
(43) Pub. Date: May 21, 2026

(54) METHOD AND SYSTEM FOR ARRANGING TASK FOR AUTONOMOUS MOBILE DEVICES

(71) Applicant: URSrobot AI Inc., Taipei City (TW)

(72) Inventors: Shih-Yu CHEN, Taipei City (TW); Sheng-Kai YOU, Taipei City (TW); Feng-Li LIAN, Taipei City (TW); Chung-Hou WU, Taipei City (TW); Chao-Cheng CHEN, Taipei City (TW)

(73) Assignee: URSrobot AI Inc., Taipei City (TW)

(21) Appl. No.: 19/180,772

(22) Filed: Apr. 16, 2025

(30) Foreign Application Priority Data
Nov. 20, 2024 (TW) 113144560

(51) Int. Cl. G06F 9/50

(52) U.S. Cl. CPC G06F 9/5027

(57) ABSTRACT

A method for arranging a task for multiple autonomous mobile devices in a specific area is implemented by a system that stores an area dataset and a device dataset. The area dataset indicates a first area for the autonomous mobile devices to cooperatively perform the task, and a second area where each autonomous mobile device approaches upon completing a part of the task assigned thereto. The device dataset indicates a predetermined speed for the autonomous mobile devices to move at. The method includes: obtaining a path dataset that indicates a moving path in the first area; obtaining multiple operation parameters based on the path dataset and the device dataset, and defining multiple path portions that collectively form the moving path based on the operation parameters; and controlling the autonomous mobile devices to perform the task in the first area based on the path portions.

### CROSS-REFERENCE TO RELATED APPLICATION

This application claims priority to Taiwanese Invention Patent Application No. 113144560, filed on Nov. 20, 2024, the entire disclosure of which is incorporated by reference herein.

### FIELD

The disclosure relates to a method for arranging a task, and more particularly to a method and a system for arranging a task for autonomous mobile devices in a specific area.

### BACKGROUND

A conventional method for mowing a lawn includes controlling a plurality of robot lawn mowers to cooperatively mow the lawn at the same time. However, when one of the robot lawn mowers has completed its part of the lawn and is to leave the lawn, the robot lawn mower may block the path of other robot lawn mowers that are still mowing the lawn, or may be blocked by other robot lawn mowers. In such a case, an efficiency for mowing the lawn may be reduced, or may even cause damage to the robot lawn mowers due to collisions between them.

### SUMMARY

Therefore, an object of the disclosure is to provide a method and a system for arranging a task for a plurality of autonomous mobile devices in a specific area that can alleviate at least one of the drawbacks of the prior art.

According to an aspect of the disclosure, a method for arranging a task for a plurality of autonomous mobile devices in a specific area is to be implemented by a system that stores an area dataset and a device dataset. The area dataset indicates a first area where the autonomous mobile devices are to cooperatively perform the task, and a second area where each of the autonomous mobile devices is to approach upon completing a part of the task that is assigned to the autonomous mobile device. The device dataset includes speed setting data that indicates a predetermined speed for the autonomous mobile devices to move at when performing the task in the first area.

The method includes obtaining a path dataset that indicates a moving path in the first area. The method further includes obtaining a plurality of operation parameters based on the path dataset and the device dataset, and defining a plurality of path portions that collectively form the moving path in a continuous manner based on the operation parameters. The operation parameters are different from each other and are either a set of distance parameters respectively indicating a plurality of distances or a set of time parameters respectively indicating a plurality of time periods. The path portions respectively define a plurality of subareas of the first area that correspond respectively to the operation parameters and that are arranged side by side in such a manner that the smaller an operation parameter is, the closer a subarea that is associated with the operation parameter is to the second area. The method further includes controlling the autonomous mobile devices to perform the task in the first area based on the path portions.

According to another aspect of the disclosure, a system for arranging a task for a plurality of autonomous mobile devices in a specific area is provided. The system includes a processing device and a storage medium that is electrically connected to the processing device. The storage medium is configured to store an area dataset and a device dataset. The area dataset indicates a first area where the autonomous mobile devices are to cooperatively perform the task, and a second area where each of the autonomous mobile devices is to approach upon completing a part of the task that is assigned to the autonomous mobile device. The device dataset includes speed setting data that indicates a predetermined speed for the autonomous mobile devices to move at when performing the task in the first area.

The processing device is configured to obtain a path dataset that indicates a moving path in the first area. The processing device is further configured to obtain a plurality of operation parameters based on the path dataset and the device dataset, and define a plurality of path portions that collectively form the moving path in a continuous manner based on the operation parameters. The operation parameters are different from each other and are either a set of distance parameters respectively indicating a plurality of distances or a set of time parameters respectively indicating a plurality of time periods. The path portions respectively define a plurality of subareas of the first area that correspond respectively to the operation parameters and that are arranged side by side in such a manner that the smaller an operation parameter is, the closer a subarea that is associated with the operation parameter is to the second area. The processing device is further configured to control the autonomous mobile devices to perform the task in the first area based on the path portions.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a system for arranging a task for a plurality of autonomous mobile devices according to an embodiment of the disclosure.

FIG. 2 is a flow chart of a method for arranging a task for a plurality of autonomous mobile devices according to a first embodiment of the disclosure.

FIG. 3 is a flow chart illustrating sub-steps of a step of obtaining a plurality of operation parameters according to the first embodiment of the disclosure.

FIG. 4 is a schematic diagram illustrating an example of a first area and a second area.

FIG. 5 is a schematic diagram illustrating another example of the first area and the second area.

FIG. 6 is a flow chart of the method according to a second embodiment of the disclosure.

FIG. 7 is a flow chart illustrating sub-steps of the step of obtaining the operation parameters according to the second embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “electrically connected to” may refer to coupling or a direct connection among a plurality of pieces of electrical apparatus/devices/equipment via an electrically conductive material (e.g., an electrical wire), or an indirect connection between two pieces of electrical apparatus/devices/equipment via another one or more pieces of apparatus/devices/equipment, or wireless communication technology (e.g., Wi-Fi, Bluetooth®, or electromagnetic induction).

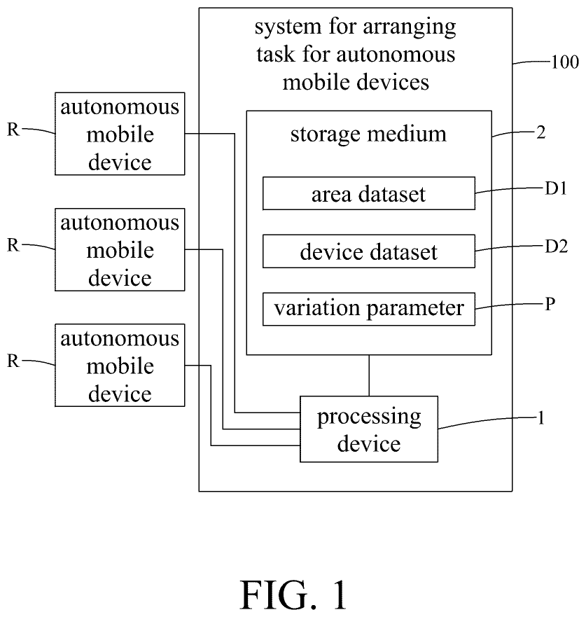

Referring to FIG. 1, according to an embodiment of the disclosure, a system 100 for arranging a task for a plurality of autonomous mobile devices (R) in a specific area is provided. In the following description, three autonomous mobile devices (R) (as shown in FIG. 1) are exemplified for simplicity, but the disclosure is not limited to such. In this embodiment, each of the autonomous mobile devices (R) is a robot lawn mower that is configured to automatically mow lawns, and the specific area is a lawn, but the disclosure is not limited to such.

The system 100 may be implemented as a server, or a collection of multiple servers. The system 100 includes a processing device 1 and a storage medium 2 that is electrically connected to the processing device 1. The processing device 1 is configured to be electrically connected to the autonomous mobile devices (R) to communicate with the autonomous mobile devices (R). The processing device 1 may include, but is not limited to, one or more of a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), a system on a chip (SoC), etc. The processing device 1 may further include one or more of a radio-frequency integrated circuit (RFIC), or a short-range wireless communication module supporting a short-range wireless communication network using a wireless technology such as Bluetooth® and/or Wi-Fi, etc.

The storage medium 2 may be embodied using one or more computer-readable storage mediums such as hard disk drives, random access memory (RAM), read only memory (ROM), programmable ROM (PROM), flash memory, etc. In this embodiment, the storage medium 2 stores an area dataset (D1), a device dataset (D2), and a variation parameter (p).

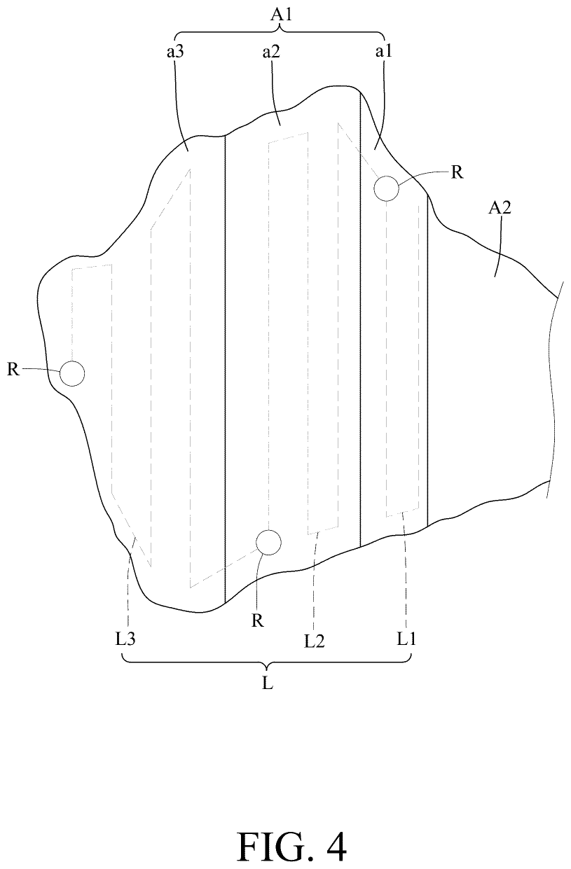

Referring further to FIG. 4, the area dataset (D1) indicates a first area (A1) (i.e., the specific area) where the autonomous mobile devices (R) are to cooperatively perform the task, and a second area (A2) where each of the autonomous mobile devices (R) is to approach upon completing a part of the task that is assigned to the autonomous mobile device (R). In this embodiment, the area dataset (D1) includes a plurality of pairs of coordinates (e.g., each pair of coordinates includes a latitude and a longitude) that cooperatively define the first area (A1) and the second area (A2). That is to say, the area dataset (D1) indicates absolute geographical locations of the first area (A1) and the second area (A2). In some embodiments, the area dataset (D1) may include data indicating relative relationship between a position of the first area (A1) and a position of the second area (A2).

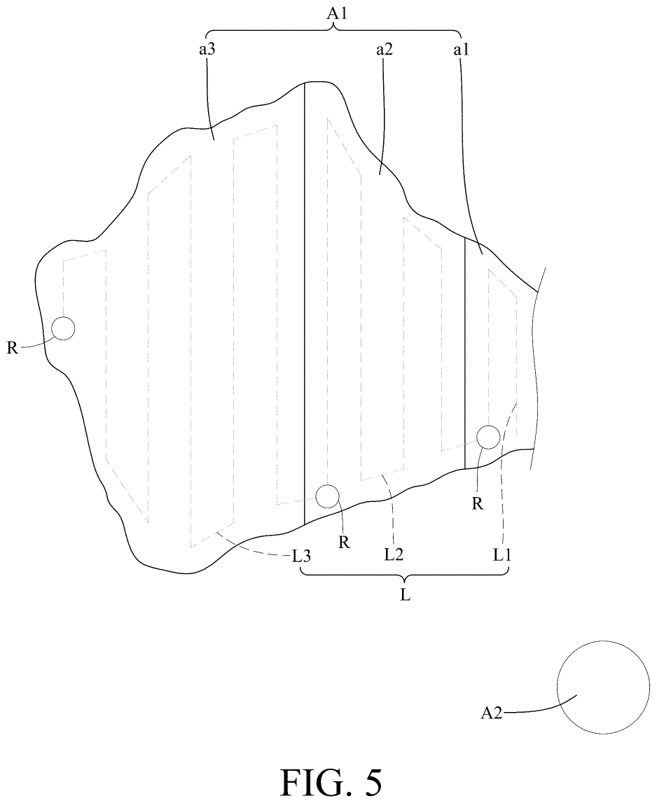

In one example as exemplified in FIG. 4, the first area (A1) is an area (e.g., a portion of a lawn) for the autonomous mobile devices (R) to perform the task (e.g., mowing operation), and the second area (A2) is another area (e.g., another portion of the lawn) for each autonomous mobile device (R) to approach upon completing the mowing operation in the first area (A1) that is assigned to the autonomous mobile device (R). Each of the autonomous mobile devices (R) may further perform other mowing operations in the second area (A2). In another example as exemplified in FIG. 5, the second area (A2) is an area that includes charging stations (not shown) for the autonomous mobile devices (R) to approach for recharging, or an area for the autonomous mobile devices (R) to be kept or to be picked up by a user.

It should be noted that the first area (A1) and the second area (A2) shown in FIGS. 4 and 5 are merely illustrative examples, and it should be understood that the shapes of the first area (A1) and the second area (A2) and the position distribution thereof may be different and depend on the actual environment where the autonomous mobile devices (R) are to be operated in, and the disclosure should not be limited to such. In addition, the manner of obtaining the area dataset (D1) is well known in the art, and will be omitted herein for the sake of brevity.

The device dataset (D2) includes speed setting data that indicates a predetermined speed for the autonomous mobile devices (R) to move at when performing the task in the first area (A1). In one example, the speed setting data indicates that the autonomous mobile devices (R) are to be moving at a speed of 1.2 km/h when performing the task in the first area (A1). The device dataset (D2) may be determined according to the specification of the autonomous mobile devices (R), and/or may be adjusted by the user.

In a first embodiment, the variation parameter (P) indicates a time interval that is related to a difference in a plurality of time periods which are respectively for the autonomous mobile devices (R) to complete the assigned parts of the task in the first area (A1). In one example, when the time interval indicated by the variation parameter (P) is 5 minutes, the time periods for the autonomous mobile devices (R) to complete the assigned parts of the task in the first area (A1) will vary from each other by 5 minutes (details will be explained later). It should be noted that a value of the time interval may be adjusted by the user according to user needs and should not be limited to the abovementioned example.

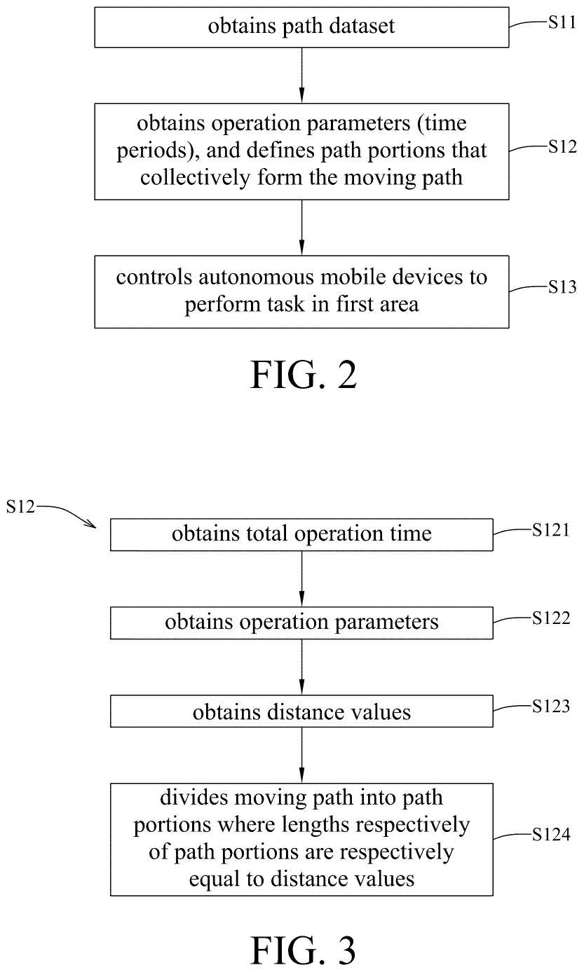

Referring further to FIG. 2, a method for arranging a task for the autonomous mobile devices (R) in a specific area according to the first embodiment of the disclosure includes steps S11 to S13. The method is to be implemented by the system 100 of FIG. 1.

In step S11, the processing device 1 obtains a path dataset that indicates a moving path (L) in the first area (A1) (as shown in FIG. 4). To describe in further detail, the path dataset includes a sequence of multiple pairs of coordinates that correspond respectively to a plurality of points which collectively form the moving path (L) when connected in sequence. In one example, each segment of the moving path (L) that is defined by two adjacent points is substantially equal in distance. In one embodiment, the processing device 1 generates the path dataset based on the area dataset (D1). Specifically, the processing device 1 generates the path dataset by determining information of the first area (A1) (e.g., the shape and size of the first area (A1), obstacle(s) in the first area (A1), etc.) based on the area dataset (D1), and then generates the path dataset according to the above-mentioned information. In another embodiment, the processing device 1 receives the path dataset from an external electrical device (e.g., a smartphone or another server). Since a method for generating the path dataset is known to one having ordinary skill in the art and is not the emphasis of this disclosure, it will not be described in further detail for the sake of brevity. After step S11, the flow of the method proceeds to step S12.

In step S12, the processing device 1 obtains a plurality of operation parameters based on the path dataset, the speed setting data included in the device dataset (D2), and the time interval indicated by the variation parameter (P). The processing device 1 further defines a plurality of path portions that collectively form the moving path (L) in a continuous manner based on the operation parameters. That is, the processing device 1 divides the moving path (L) into the plurality of path portions.

In this embodiment, a quantity of the operation parameters is equal to a quantity of the autonomous mobile devices (R) (e.g., the quantity is equal to three). The operation parameters respectively indicate the time periods for the autonomous mobile devices (R) to cooperatively perform the task (i.e., the time periods for the autonomous mobile device (R) to complete the assigned parts of the task). The time periods are in an arithmetic sequence with a common difference equal to the time interval indicated by the variation parameter (P). For explanation purposes, in the following description, the operations parameters are referred to as a first operation parameter, a second operation parameter, and a third operation parameter that are associated respectively with the three autonomous mobile devices (R).

In this embodiment, the path portions respectively define a plurality of subareas of the first area (A1). The subareas correspond respectively to the operation parameters (i.e., the time periods) and are arranged side by side in such a manner that the smaller the operation parameter is, the closer a subarea that is associated with the operation parameter is to the second area (A2).

As shown in FIG. 4, for explanation purposes, the path portions that collectively form the moving path (L) include a first path portion (L1), a second path portion (L2), and a third path portion (L3), where the first path portion (L1) corresponds to the first operation parameter, the second path portion (L2) corresponds to the second operation parameter, and the third path portion (L3) corresponds to the third operation parameter. Additionally, in the example shown in FIG. 4, the subareas of the first area (A1) include a first subarea (a1) that is defined by the first path portion (L1), a second subarea (a2) that is defined by the second path portion (L2), and a third subarea (a3) that is defined by the third path portion (L3).

To describe in further detail, the first operation parameter indicates the time period for one of the autonomous mobile devices (R) (hereinafter referred to as “first autonomous mobile device”) to perform its part of the task in the first subarea (a1), where the first autonomous mobile device (R) moves along the first path portion (L1) while performing its part of the task. Similarly, the second operation parameter indicates the time period for another one of the autonomous mobile devices (R) (hereinafter referred to as “second autonomous mobile device”) to perform its part of the task in the second subarea (a2), where the second autonomous mobile device (R) moves along the second path portion (L2) while performing its part of the task. The third operation parameter indicates the time period for yet another one of the autonomous mobile devices (R) (hereinafter referred to as “third autonomous mobile device”) to perform its part of the task in the third subarea (a3), where the third autonomous mobile device (R) moves along the third path portion (L3) while performing its part of the task.

In the example shown in FIG. 4, among the subareas (a1, a2, a3), the first subarea (a1) is the closest to the second area (A2), and the first operation parameter that corresponds to the first subarea (a1) is a smallest one among the operation parameters. Similarly, among the subareas (a1, a2, a3), the third subarea (a3) is the farthest from the second area (A2), and the third operation parameter that corresponds to the third subarea (a3) is a largest one among the operation parameters.

Referring further to FIG. 3, in the first embodiment, step S12 includes sub-steps S121 to S124.

In sub-step S121, the processing device 1 obtains a total operation time based on the speed setting data and a total path length that is indicated by the path dataset and that corresponds to the moving path (L). The total path length is the total length of the moving path (L). In one example, the total path length is equal to 12 km, the speed indicated by the speed setting data is equal to 1.2 km/h, and therefore, the total operation time is calculated as a quotient of the total path length and the speed, which is equal to 10 hours.

In sub-step S122, the processing device 1 obtains the operation parameters based on the total operation time, the quantity of the autonomous mobile devices (R), and the variation parameter (P). In one example where the quantity of the autonomous mobile devices (R) is equal to three and the variation parameter (P) is equal to 5 minutes, the first operation parameter, the second operation parameter, and the third operation parameter are respectively equal to 195 minutes, 200 minutes, and 205 minutes. However, the disclosure is not limited to the abovementioned example. It should be noted that a sum of the operation parameters is equal to the total operation time.

In sub-step S123, the processing device 1 obtains a plurality of distance values based on the operation parameters and the speed setting data, where a sum of the distance values is equal to the total path length. In the above-mentioned example, the distance values are respectively equal to 3.9 km (i.e., a distance when moving at 1.2 km/h for 195 minutes), 4.0 km (i.e., a distance when moving at 1.2 km/h for 200 minutes), and 4.1 km (i.e., a distance when moving at 1.2 km/h for 205 minutes), where a sum of the three distance values (which is equal to 12 km) is equal to the total path length (12 km).

In sub-step S124, the processing device 1 divides the moving path (L) into the path portions in such a manner that a plurality of lengths respectively of the path portions are respectively equal to the distance values. In one example as exemplified in FIG. 4, the processing device 1 divides the moving path (L) into the first path portion (L1) being equal to 3.9 km, the second path portion (L2) being equal to 4.0 km, and the third path portion (L3) being equal to 4.1 km. It should be noted that each of the path portions is formed by connecting in sequence a group of the pairs of coordinates (i.e., the points) in the path dataset.

To describe in further detail, the processing device 1 first selects, from the path dataset, an n^{th} pair of coordinates which satisfies a condition that a length of connecting from a first pair of coordinates in the path dataset to the n^{th} pair of coordinates through all intermediate pairs of coordinates between the first pair of coordinates and the n^{th} pair of coordinates (i.e., a second pair, a third pair, . . . and an (n−1)^{th} pair) in sequence is equal to or close to the distance value for the first path portion (L1). Then, the processing device 1 defines the first path portion (L1) to be a connection from the first pair of coordinates to the n^{th} pair of coordinates through the intermediate pairs of coordinates therebetween (i.e., the first pair, the second pair, the third pair, . . . , and the n^{th} pair). Subsequently, the processing device 1 selects, from the path dataset, an m^{th} pair of coordinates which satisfies a condition that a length of connecting from the n^{th} pair of coordinates to the m^{th} pair of coordinates through all intermediate pairs of coordinates therebetween in sequence is equal to or close to the distance value for the second path portion (L2), and defines a connection from the n^{th} pair of coordinates to the m^{th} pair of coordinates through the intermediate pairs of coordinates therebetween as the second path portion (L2). Then, the processing device 1 defines a connection from the m^{th} pair of coordinates to a last pair of coordinates in the path dataset through the intermediate pairs of coordinates therebetween as the third path portion (L3).

In one example, the path dataset includes 30 pairs of coordinates that correspond respectively to 30 points which collectively form the moving path (L). The processing device 1 defines the first path portion (L1) to be from the first pair of coordinates to the seventh pair of coordinates, where a length of a connection from the first pair of coordinates to the seventh pair of coordinates is equal to the distance value for the first path portion (L1); the processing device 1 defines the second path portion (L2) to be from the seventh pair of coordinates to the seventeenth pair of coordinates, where a length of a connection from the seventh pair of coordinates to the seventeenth pair of coordinates is equal to the distance value for the second path portion (L2); the processing device 1 defines the third path portion (L3) to be from the seventeenth pair of coordinates to the last pair of coordinates (i.e., the thirtieth pair of coordinates), but the disclosure is not limited to such.

After sub-step S124, the flow proceeds to step S13, where the processing device 1 controls the autonomous mobile devices (R) to perform the task in the first area (A1) based on the path portions. In this embodiment, the processing device 1 generates, for each of the autonomous mobile devices (R), path portion data (e.g., including a group of the pairs of coordinates that are associated with the respective one of the path portions) that indicates the respective one of the path portions, and sends the path portion data to the autonomous mobile device (R), so that the autonomous mobile device (R) moves along the path portion indicated by the path portion data for performing that part of the task that is assigned to the autonomous mobile device (R) in the first area (A1).

It should be noted that the first autonomous mobile device (R) that operates in the first subarea (a1) will complete its part of the task (i.e., mowing the first subarea (a1)) faster than the rest of the autonomous mobile devices (R) (since the first path portion (L1) is the shortest among the path portions (L1, L2, L3)), and will leave the first subarea (a1) (i.e., leaves the first area (A1)) and approach the second area (A2). As such, when the second autonomous mobile device (R) that operates in the second subarea (a2) completes its part of the task (i.e., mowing the second subarea (a2)) and starts to approach the second area (A2), even though the second autonomous mobile device (R) would need to move across the first subarea (a1) to arrive at the second area (A2), since the first autonomous mobile device (R) has already left the first subarea (a1), the second autonomous mobile device (R) may approach the second area (A2) without a risk of colliding with the first autonomous mobile device (R).

In one example using the abovementioned operation parameters (i.e., 195 minutes, 200 minutes, and 205 minutes), the first autonomous mobile device (R) completes its part of the task in the first area (A1) earlier than the second autonomous mobile device (R) by 5 minutes, and approaches the second area (A2) to further perform the task in the second area (A2). The second autonomous mobile device (R) completes its part of the task in the first area (A1) earlier than the third autonomous mobile device (R) by 5 minutes, and approaches the second area (A2) to further perform the task in the second area (A2). In such a case, for the second area (A2), the processing device 1 may further obtain multiple operation parameters (e.g., time periods) that are identical to each other based on the speed setting data and another path dataset that corresponds to the second area (A2), so that each of the autonomous mobile devices (R) performs the task in the second area (A2) for the same duration (i.e., the time periods are identical), but the start times respectively for the autonomous mobile devices (R) to perform the task in the second area (A2) are offset by approximately five minutes (since the autonomous mobile devices (R) would arrive at the second area (A2) with a difference in arrival times of approximately five minutes).

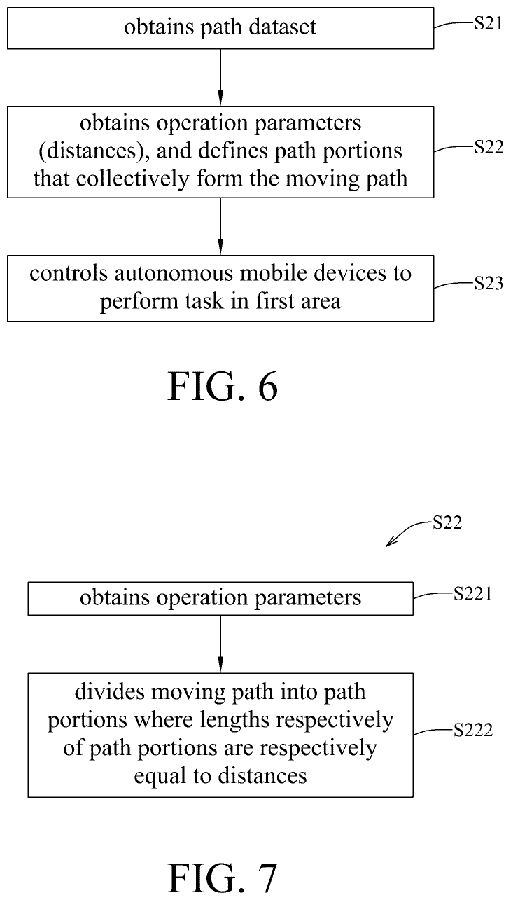

Referring further to FIGS. 6 and 7, the method according to a second embodiment of the disclosure is provided. Different from the first embodiment, the variation parameter (P) in the second embodiment indicates a distance difference that is related to a difference in a plurality of distances for the autonomous mobile devices (R) to move when performing the task in the first area (A1). In one example, when the distance difference indicated by the variation parameter (P) is equal to 0.1 km, the distances for the autonomous mobile devices (R) to move when performing the task in the first area (A1) will vary from each other by 0.1 km (details will be explained later). It should be noted that a value of the distance difference may be adjusted by the user according to user needs and should not be limited to the abovementioned example.

The method according to the second embodiment of the disclosure includes steps S21 to S23. Step S21 in the second embodiment is similar to step S11 in the first embodiment, where the processing device 1 obtains the path dataset that indicates the moving path (L) in the first area (A1).

In step S22, the processing device 1 obtains the operation parameters based on the path dataset, the speed setting data included in the device dataset (D2), and the distance difference indicated by the variation parameter (P). The processing device 1 further defines the path portions that collectively form the moving path (L) in a continuous manner based on the operation parameters.

Different from the first embodiment, the operation parameters obtained in the second embodiment respectively indicate the distances for the autonomous mobile devices (R) to respectively move when cooperatively performing the task, and the distances are in an arithmetic sequence with a common difference equal to the distance difference indicated by the variation parameter (P). The path portions respectively define the subareas of the first area (A1). The subareas correspond respectively to the operation parameters (i.e., the distances) and are arranged side by side in such a manner that the smaller the operation parameter is, the closer a subarea of the subareas that is associated with the operation parameter is to the second area (A2).

In this embodiment, step S22 includes sub-steps S221 and S222. In step S221, the processing device 1 obtains the operation parameters based on the total path length that is indicated by the path dataset and that corresponds to the moving path (L), the quantity of the autonomous mobile devices (R), and the variation parameter (P). In one example, the total path length is equal to 12 km, the quantity of the autonomous mobile devices (R) is equal to three, and the distance difference indicated by the variation parameter (P) is equal to 0.1 km. Therefore, the operation parameters are respectively equal to 3.9 km, 4.0 km, and 4.1 km. In another example, the distance difference indicated by the variation parameter (P) is equal to 0.2 km instead, and therefore the operation parameters are respectively equal to 3.8 km, 4.0 km, and 4.2 km. However, the disclosure is not limited to the abovementioned example.

In sub-step S222, the processing device 1 divides the moving path (L) into the path portions in such a manner that the lengths respectively of the path portions are respectively equal to the distances indicated by the operation parameters, and the flow proceeds to step S23.

In step S23, the processing device 1 controls the autonomous mobile devices (R) to perform the task in the first area (A1) based on the path portions in a similar manner as in step S13.

In summary, according to the disclosure, the system 100 assigns the task to the autonomous mobile devices (R) such that the closer the autonomous mobile device (R) is to the second area (A2), the faster the autonomous mobile device (R) will complete its part of the task in the first area (A1), and the faster the autonomous mobile device (R) may leave the first area (A1) and approach the second area (A2). As such, when any one of the autonomous mobile devices (R) completes its part of the task and starts to approach the second area (A2), the autonomous mobile device (R) may arrive at the second area (A2) without a risk of colliding with other autonomous mobile devices (R) in the first area (A1).

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for arranging a task for a plurality of autonomous mobile devices in a specific area, the method to be implemented by a system that stores an area dataset and a device dataset, the area dataset indicating a first area where the plurality of autonomous mobile devices are to cooperatively perform the task, and a second area where each autonomous mobile device of the plurality of autonomous mobile devices is to approach upon completing a part of the task that is assigned to the autonomous mobile device, the device dataset including speed setting data that indicates a predetermined speed for the plurality of autonomous mobile devices to move at when performing the task in the first area, the method comprising:
obtaining a path dataset that indicates a moving path in the first area;
obtaining a plurality of operation parameters based on the path dataset and the device dataset, and defining a plurality of path portions that collectively form the moving path in a continuous manner based on the plurality of operation parameters, wherein the plurality of operation parameters are different from each other and are one of a set of distance parameters respectively indicating a plurality of distances and a set of time parameters respectively indicating a plurality of time periods, wherein the plurality of path portions respectively define a plurality of subareas of the first area that correspond respectively to the plurality of operation parameters and that are arranged side by side in such a manner that the smaller an operation parameter of the plurality of operation parameters is, the closer a subarea of the plurality of subareas that is associated with the operation parameter is to the second area; and
controlling the plurality of autonomous mobile devices to perform the task in the first area based on the plurality of path portions.

2. The method as claimed in claim 1, the system further storing a variation parameter that indicates a time interval,
wherein the plurality of operation parameters are obtained further based on the variation parameter, and the plurality of operation parameters respectively indicate the plurality of time periods that are in an arithmetic sequence with a common difference equal to the time interval.

3. The method as claimed in claim 2, wherein obtaining the plurality of operation parameters and defining the plurality of path portions include:
obtaining a total operation time based on the speed setting data and a total path length that is indicated by the path dataset and that corresponds to the moving path;
obtaining the plurality of operation parameters based on the total operation time, a quantity of the plurality of autonomous mobile devices, and the variation parameter;
obtaining a plurality of distance values based on the plurality of operation parameters and the speed setting data, where a sum of the plurality of distance values is equal to the total path length; and
dividing the moving path into the plurality of path portions in such a manner that a plurality of lengths respectively of the plurality of path portions are respectively equal to the plurality of distance values.

4. The method as claimed in claim 1, the system further storing a variation parameter that indicates a distance difference,
wherein the plurality of operation parameters are obtained further based on the variation parameter, and the plurality of operation parameters respectively indicate the plurality of distances that are in an arithmetic sequence with a common difference equal to the distance difference.

5. The method as claimed in claim 4, wherein obtaining the plurality of operation parameters and defining the plurality of path portions include:
obtaining the plurality of operation parameters based on a total path length that is indicated by the path dataset and that corresponds to the moving path, a quantity of the plurality of autonomous mobile devices, and the variation parameter; and
dividing the moving path into the plurality of path portions in such a manner that a plurality of lengths respectively of the plurality of path portions are respectively equal to the plurality of distances indicated by the plurality of operation parameters.

6. The method as claimed in claim 1, wherein obtaining the path dataset is to obtain the path dataset based on the area dataset.

7. A system for arranging a task for a plurality of autonomous mobile devices in a specific area, the system comprising:
a processing device;
a storage medium electrically connected to said processing device and configured to store an area dataset and a device dataset, the area dataset indicating a first area where the plurality of autonomous mobile devices are to cooperatively perform the task, and a second area where each autonomous mobile devices of the plurality of autonomous mobile devices is to approach upon completing a part of the task that is assigned to the autonomous mobile device, the device dataset including speed setting data that indicates a predetermined speed for the plurality of autonomous mobile devices to move at when performing the task in the first area;
wherein said processing device is configured to
obtain a path dataset that indicates a moving path in the first area,
obtain a plurality of operation parameters based on the path dataset and the device dataset, and define a plurality of path portions that collectively form the moving path in a continuous manner based on the plurality of operation parameters, where the plurality of operation parameters are different from each other and are one of a set of distance parameters respectively indicating a plurality of distances and a set of time parameters respectively indicating a plurality of time periods, where the plurality of path portions respectively define a plurality of subareas of the first area that correspond respectively to the plurality of operation parameters and that are arranged side by side in such a manner that the smaller an operation parameter of the plurality of operation parameters is, the closer a subarea of the plurality of subareas that is associated with the operation parameter is to the second area, and
control the plurality of autonomous mobile devices to perform the task in the first area based on the plurality of path portions.

8. The system as claimed in claim 7, wherein said storage medium is configured to further store a variation parameter that indicates a time interval, and said processing device is configured to obtain the plurality of operation parameters further based on the variation parameter, such that the plurality of operation parameters respectively indicate the plurality of time periods that are in an arithmetic sequence with a common difference equal to the time interval.

9. The system as claimed in claim 8, wherein said processing device is configured to obtain the plurality of operation parameters and define the plurality of path portions by:
obtaining a total operation time based on the speed setting data and a total path length that is indicated by the path dataset and that corresponds to the moving path;
obtaining the plurality of operation parameters based on the total operation time, a quantity of the plurality of autonomous mobile devices, and the variation parameter;
obtaining a plurality of distance values based on the plurality of operation parameters and the speed setting data, where a sum of the plurality of distance values is equal to the total path length; and
dividing the moving path into the plurality of path portions in such a manner that a plurality of lengths respectively of the plurality of path portions are respectively equal to the plurality of distance values.

10. The system as claimed in claim 7, wherein said storage medium is configured to further store a variation parameter that indicates a distance difference, and said processing device is configured to obtain the plurality of operation parameters further based on the variation parameter, such that the plurality of operation parameters respectively indicate the plurality of distances that are in an arithmetic sequence with a common difference equal to the distance difference.

11. The system as claimed in claim 10, wherein said processing device is configured to obtain the plurality of operation parameters and define the plurality of path portions by:
obtaining the plurality of operation parameters based on a total path length that is indicated by the path dataset and that corresponds to the moving path, a quantity of the plurality of autonomous mobile devices, and the variation parameter; and
dividing the moving path into the plurality of path portions in such a manner that a plurality of lengths respectively of the plurality of path portions are respectively equal to the plurality of distances indicated by the plurality of operation parameters.

12. The system as claimed in claim 7, wherein said processing device is configured to obtain the path dataset based on the area dataset.
